(19) United States
(12) Patent Application Publication
(10) Pub. No.: US 2009/0189475 A1
(43) Pub. Date: Jul. 30, 2009

(54) Motor, method for fabricating the same, and home appliance with the same

(75) Inventor: Sung Yong SHIN, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Yeongdeungpo-gu (KR)

(21) Appl. No.: 12/320,534

(22) Filed: Jan. 28, 2009

(30) Foreign Application Priority Data
Jan. 29, 2008 (KR) 10-2008-0009145
Jan. 29, 2008 (KR) 10-2008-0009146

(51) Int. Cl. H02K 3/52

(52) U.S. Cl. 310/195

(57) ABSTRACT

The present invention relates a motor, a method for fabricating the same and a home appliance with the same.

The motor includes a stator having a coil wound thereon, a rotor mounted to be rotatable with respect of the stator, a tap terminal positioned at a terminal of the coil, a magmate placed in the tap terminal for electric connection to a core line of the coil and fastening the coil to the tap terminal, and an insulation portion at the magmate for forming an insulation coating at an exposed portion of the core line, thereby reducing a production cost and improving productivity and reliability.

### CROSS REFERENCE TO RELATED APPLICATION

This application claims the benefit of the Patent Korean Application No. 10-2008-0009145, filed on Jan. 29, 2008, and Korean Application No. 10-2008-0009146, filed on Jan. 29, 2008, each of which are hereby incorporated by reference as if fully set forth herein.

### BACKGROUND OF THE DISCLOSURE

1. Field of the Disclosure

The present invention relates to motors, and more particularly, to a motor which can save a production cost and can improve production and reliability; and a method for fabricating the same and a home appliance with the same.

2. Discussion of the Related Art

Though the motor of the present invention may be a motor applicable to a home appliance which is comparatively bulky, such as a washing machine, a dryer, or a dish washer, and has an environment of use which is humid and has a temperature higher than a room temperature; a method for fabricating the same, and a home appliance with the same, the application of the motor is not limited to above.

In general, the motor transmits rotating force of a rotor to a rotation shaft, and the rotation shaft drives a load. For an example, the rotation shaft may be connected to a drum of the washing machine for driving the drum, or connected to a fan of a refrigerator to drive the fan for supplying cold air to a required space.

In the meantime, in such a motor, the rotor rotates owing to electromagnetic interaction with a stator. For this, the stator has a coil wound thereon, and as a current is applied to the coil, the rotor is rotated by the stator.

In general, the coil is formed of copper, because the copper has a good electric conductivity and ductility good to have less damage at the time of winding.

However, the copper is expensive to increase the production cost of the motor. Moreover, there have been frequent cases when copper price rises sharply in international market to fail to have a stable supply of the copper.

According to this, it is necessary to use the coil of a material, other than the copper, for saving the production cost of the motor, and have stable supply of the copper. However, even if the coil of a material other than the copper used, it is required to fabricate the motor having a quality at least the same with a case the copper coil is used.

In the meantime, it is preferable that a related art configuration is not changed even if the copper coil is replaced with a coil of other material, because, if it is required to re-design and re-fabricate other essential configuration even if a cost of the coil is saved, an initial investment is liable to increase, excessively.

### SUMMARY OF THE DISCLOSURE

Accordingly, the present invention is directed to a motor, a method for fabricating the same and a home appliance with the same.

An object of the present invention is to provide a motor, a method for fabricating the same and a home appliance with the same, for reducing a production cost of a motor by saving a cost of a coil, and reducing a production cost of a home appliance on the whole by applying the motor to the home appliance.

Another object of the present invention is to provide a motor which can be fabricated easily, and can enhance product reliability and endurance, a method for fabricating the same and a home appliance with the same.

Another object of the present invention is to provide a motor which can minimize defective line connection, a method for fabricating the same and a home appliance with the same.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a motor includes a stator having a coil wound thereon, a rotor mounted to be rotatable with respect of the stator, a tap terminal positioned at a terminal of the coil, a magmate placed in the tap terminal for electric connection to a core line of the coil and fastening the coil to the tap terminal, and an insulation portion at the magmate for forming an insulation coating at an exposed portion of the core line.

Preferably, the stator includes a stator core, and an insulator for insulating the stator core.

Preferably, the coil is formed of aluminum.

Preferably, the tap terminal is mounted to the insulator.

Preferably, the tap terminal is formed as one unit with the insulator.

Preferably, the tap terminal is either a power connection tap terminal, or a neutral point tap terminal.

Preferably, the motor further includes a strength reinforcing portion at one side of the tap terminal for reinforcing strength of the tap terminal and the terminal of the coil.

Preferably, the strength reinforcing portion is formed as one unit with the tap terminal.

Preferably, the strength reinforcing portion includes an insertion portion for inserting the coil therein and a seating portion for seating the coil thereon.

Preferably, the insertion portion has a width for enabling forced insertion of the coil therethrough, and the seating portion has a width greater than the width of the insertion portion.

Preferably, the seating portion has a curved surface for increasing a contact area to the coil.

Preferably, the magmate includes a front, a rear, and a bottom, and the front, the rear, and the bottom have slots in the middles of the front, the rear, and the bottom respectively for placing the coil therein.

Preferably, the magmate is formed such that the front and the rear are parallel to each other, and the bottom is bent perpendicular to the front and the rear for reinforcing strength.

Preferably, the insulation portion is provided to portion excluding slot portions of the front and the rear of the magmate.

Preferably, the insulation portion is provided to an inside wall and an outside wall of each of the front and the rear of the magmate.

Preferably, the insulation portion is provided to portions of the magmate excluding a portion of the magmate in contact with the core line.

Preferably, the magmate includes a connection portion for connection to an external power source.

Preferably, the connection portion is formed to be projected to an outside of the tap terminal.

Preferably, the connection portion is sloped to an inside of the magmate.

Preferably, the insulation portion is a thermosetting type film to be adhered to the magmate.

In another aspect of the present invention, a home appliance operable by rotation force of a motor includes a base for mounting the motor thereon and a connector for applying an external power source to the motor, wherein the motor includes a stator fixed to the base, a rotor mounted to be rotatable with respect of the stator, a tap terminal positioned at a terminal of the coil, a magmate placed in the tap terminal for electric connection to a core line of the coil and fastening the coil to the tap terminal, and an insulation portion at the magmate for forming an insulation coating at an exposed portion of the core line.

Preferably, the stator includes a stator core, and an insulator for insulating the stator core.

Preferably, the coil is formed of aluminum.

Preferably, the tap terminal is mounted to the insulator.

Preferably, the tap terminal is formed as one unit with the insulator.

Preferably, the tap terminal is either a power connection tap terminal, or a neutral point tap terminal.

Preferably, the home appliance further includes a strength reinforcing portion at one side of the tap terminal for reinforcing strength of the tap terminal and the terminal of the coil.

Preferably, the strength reinforcing portion is formed as one unit with the tap terminal.

Preferably, the strength reinforcing portion includes an insertion portion for inserting the coil therein and a seating portion for seating the coil thereon.

Preferably, the insertion portion has a width for enabling forced insertion of the coil therethrough, and the seating portion has a width greater than the width of the insertion portion.

Preferably, the seating portion has a curved surface for increasing a contact area to the coil.

Preferably, the magmate includes a front, a rear, and a bottom, and the front, the rear, and the bottom have slots in the middles of the front, the rear, and the bottom respectively for placing the coil therein.

Preferably, the magmate is formed such that the front and the rear are parallel to each other, and the bottom is bent perpendicular to the front and the rear for reinforcing strength.

Preferably, the insulation portion is provided to portion excluding slot portions of the front and the rear of the magmate.

Preferably, the insulation portion is provided to an inside wall and an outside wall of each of the front and the rear of the magmate.

Preferably, the insulation portion is provided to portions of the magmate excluding a portion of the magmate in contact with the core line.

Preferably, the magmate includes a connection portion for connection to an external power source.

Preferably, the connection portion is formed to be projected to an outside of the tap terminal.

Preferably, the connection portion is sloped to an inside of the magmate.

Preferably, the insulation portion is a thermosetting type film to be adhered to the magmate.

In another aspect of the present invention, a method for fabricating a motor includes (A) step for winding aluminum coil on a stator core, (B) step for positioning a terminal of the coil at a tap terminal, (C) step for placing a magmate in the tap terminal for connecting a core line of the coil to the magmate electrically, and fastening the coil to the tap terminal, and (D) step for forming an insulation coating on an exposed portion of the core line for corrosion prevention and strength reinforcement of the core line. Preferably, the (D) step includes the step of heating the magmate for melting an insulation portion mounted to the magmate.

Preferably, the (D) step includes the step of coating resin on the tap terminal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings which are included to provide a further understanding of the disclosure and are incorporated in and constitute a part of this application, illustrate embodiment(s) of the disclosure and together with the description serve to explain the principle of the disclosure. In the drawings:

FIG. 1 illustrates a perspective view of a stator of a motor in accordance with a preferred embodiment of the present invention.

FIG. 2 illustrates a perspective view of a rotor of a motor in accordance with a preferred embodiment of the present invention.

FIG. 3 illustrates a perspective view of a neutral point tap terminal in accordance with a preferred embodiment of the present invention.

FIG. 4 illustrates an exploded perspective view of a neutral point tap terminal in accordance with a preferred embodiment of the present invention.

FIG. 5 illustrates a plan view showing a state of connection of a neutral point tap terminal to a coil in accordance with a preferred embodiment of the present invention.

FIG. 6 illustrates a plan view showing a state of insulation portions at the time of connection of a neutral point tap terminal to a coil in accordance with a preferred embodiment of the present invention.

FIG. 7 illustrates a perspective view showing a state of coating of insulation portions at the time of connection of a neutral point tap terminal to a coil in accordance with a preferred embodiment of the present invention.

FIG. 8 illustrates a perspective view of a magmate of a neutral point tap terminal in accordance with a preferred embodiment of the present invention.

FIG. 9 illustrates a perspective view of a magmate of a neutral point tap terminal in accordance with another preferred embodiment of the present invention.

FIG. 10 illustrates a plan view showing a state of insulation portions at the time of connection of a neutral point tap terminal to a coil in accordance with another preferred embodiment of the present invention.

FIG. 11 illustrates a perspective view of a neutral point tap terminal in accordance with another preferred embodiment of the present invention.

FIG. 12 illustrates a perspective view of a neutral point tap terminal in accordance with another preferred embodiment of the present invention.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

Attached drawings illustrate things related to a motor of a washing machine. However, the present invention is not limited to the motor of a washing machine, necessarily. Along with this, the present invention is related to a home appliance having the motor applied thereto, but the home appliance is not limited to the washing machine.

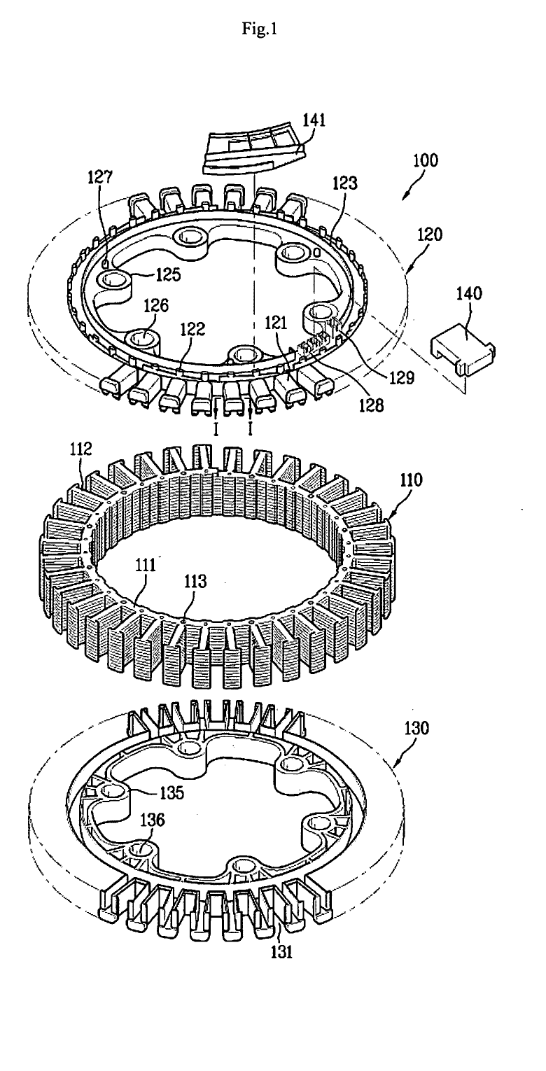

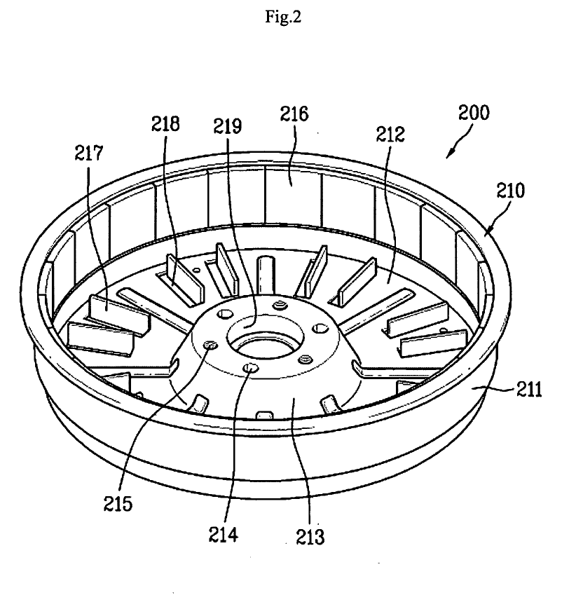

A motor in accordance with a preferred embodiment of the present invention will be described in detail, with reference to FIGS. 1 and 2.

FIG. 1 illustrates a perspective view of a stator of a motor in accordance with a preferred embodiment of the present invention, and FIG. 2 illustrates a perspective view of a rotor of a motor in accordance with a preferred embodiment of the present invention. Referring to FIGS. 1 and 2, the motor includes a stator 100 having a stator core 110, an upper insulator 120, and a lower insulator 130, and a rotor 200 having a rotor frame 210, and permanent magnets 216.

The stator core 110 will be described in detail.

Referring to FIG. 1, the stator core 110 includes an annular back yoke 111, and T's 112 projected outward from an outside circumference of the back yoke 111 in a radial direction.

Above stator is a stator of an outer rotor type motor in which the rotor 200 is provided to an outer side of the stator core 110. Opposite to this, the T's 112 may be projected inward from an inside circumference of the back yoke 111 in a radial direction. In this case, the stator 100 is a stator 100 of an inner rotor type motor.

The stator core 110 includes a annular back yoke 111 of stacked layers, and T's 112 projected from the back yoke 111 perpendicular thereto. The back yoke 111 has caulking portions 113 for joining the layers together as one body to form the stator core 110.

The stator core 110 may be layers of punched steel plates stacked together. However, this method has a high possibility of wasting material due to formation of unused circular steel piece, and so on on an inside of the stator core 111.

Therefore, it is preferable that the stator core 110 is formed in spiral type, in which the back yoke 111 and the T's 112 projected from the back yoke perpendicular thereto are stacked by bending the back yoke 111 and the T's 112, helically. FIG. 1 illustrates such a spiral type stator core 110.

The upper insulator 120 and the lower insulator 130 are mounted to an upper side and lower side of the stator core 110. That is, the upper insulator 120 and the lower insulator 130 are fastened to the stator core 110 for surrounding and insulating the stator core 110.

The upper insulator 120 and the lower insulator 130 have winding portions 121 and 131 which enclose outsides of the T's 112 projected from the back yoke 111 perpendicular thereto respectively. The coil (not shown) is wound on the winding portions 121 and 131 which enclose the T's 112. The winding portions 121 and 131 maintain insulation between the T's 112 and the coil.

In the meantime, the upper insulator 120 and the lower insulator 130 can be formed as one unit with the stator core 110. For an example, the stator core 110 may be placed between the insulators 120 and 130 before molding for forming the upper insulator 120 and the lower insulator 130 as one unit with the stator core 110. The insulators 120 and 130 may include insulating films (not shown) placed between the T's 112.

The upper insulator 120 and the lower insulator 130 have fastening bosses 125 and 135 projected in a radial direction from an inside, respectively. The fastening bosses 125 and 135 have fastening holes 126 and 136 formed therein for fastening the stator 100, respectively. The fastening holes 126 and 136 may be fastened to, for an example, a rear wall surface (not shown) of a tub of the drum type washing machine which is one kind of home appliance.

That is, the fastening hole 126 of the upper insulator 120 and the fastening hole 130 of the lower insulator 130 form one fastening hole matched to each other at the time the upper insulator 120, the stator core 110 and the lower insulator 130 are fastened, together. An entire stator 100 is fastened to the tub or the like with bolts (not shown) passed through such fastening hole.

A positioning projection 127 may be formed in the vicinity of the fastening hole 126 of the upper insulator 120. After fixing a position of the stator 100 by means of the positioning projection 127 placed in a positioning hole (not shown) in the tub or the like, the stator 100 may be fastened to the tub with the bolts described before.

The fastening means of the fastening bosses 125 and 135 and the fastening holes 126 and 136 may not fasten the stator 100 to the tub, but to a bracket (not shown) of the motor, or a motor housing (not shown).

In this instance, the name of bracket is given in view of a purpose for fixing the motor to a home appliance or the like, and the name of housing is given in view of a purpose for housing the motor or the like. However, since the same one can meet the purposes at a time, above element will be called as a bracket.

For an example, in the motor, it is required that the stator 100 is fixed relative to the rotor 200 (See FIG. 2). Therefore, means for fixing the stator 100 is required, which may be a base 212 (See FIG. 2).

The base 212 may be the bracket which forms an exterior of the motor. The motor is fastened to the home appliance as the stator 100 is fastened to the bracket at first, and the bracket is fastened or connected to the home appliance. In other words, the motor is fastened to the home appliance through the bracket.

In the meantime, because the motor may be positioned in the home appliance, the motor may not require the bracket. For an example, the stator 100 may be fastened to the rear wall of the tub, directly. Accordingly, in this case, a portion having the stator 100 fastened thereto, like the rear wall of the tub of the washing machine, may be the base.

The T's 112 of the stator 100 described above have coils of u, v, w phases wound thereon, respectively. In this instance, the T's include the winding portions 121 and 131 which insulate between the T's 112 of the stator core 110.

In order to make one T 112 to have one pole, one coil may be wound on one T 112, which is called as a concentrated winding. The more the number of poles (i.e., a number of T's 112) of the stator 100, the lower a maximum speed of the rotor 200, which makes motor control easy, and a maximum torque relatively greater.

Once winding of a u phase coil on one of the T's 112 is finished, the coil is fastened as the coil is wound on a coil winding rib 122 at the upper insulator 120, and then, is wound on the next T 112 again, skipping two T's 112.

A starting end and a last end of the coil are positioned at a power connection tap terminal 128 and a neutral point tap terminal 129, respectively. For convenience sake, the starting end and the last end will be called as terminals.

The power connection tap terminal 128 has a connector 140 connected thereto for applying a power of 3 phases to the coils of u, v, w phases, respectively. All of the terminals of the coils of three phases are connected to a neutral point tap terminal 129 electrically, to form a neutral point.

In this instance, the power connection tap terminal 128 and the neutral point tap terminal 129 have exteriors formed of an insulating material, preferably as one body with the upper insulator 120. However, this does not limit formation positions of the power connection tap terminal 128 and the neutral point tap terminal 129.

In the meantime, on one side of the power connection tap terminal 128 and the neutral point tap terminal 129, there is a hole assembly 141 fixed thereto. A position and/or speed of a rotor 200 which will be described later is sensed with the hole sensor assembly 141 for controlling phases of a voltage and intensity of a current applied thereto to control the rotation speed and a torque of the rotor 200.

On an inside of the coil winding ribs 122 in a radial direction, there are insulator ribs 123 formed on the upper insulator and the lower insulator 130, respectively. The insulator rib 123 has a height greater than a predetermined height for cutting water from flowing from an inside of the insulators 120 and 130 to the winding portions 121 and 131.

The insulator rib 123 is formed higher than a height of winding of the coil. The insulator rib 123 prevents the coil suffering from damage at the time of handling the stator 100. That is, when the stator is placed on a floor, only the insulator rib 123 is brought into contact with the floor, but not the coil, thereby preventing the coil suffering from damage.

The rotor 200 of the present invention will be described.

As described before, the rotor 200 includes a rotor frame 210, and permanents magnets 216.

The rotor frame 210 has a base 212, and a sidewall portion 211 formed along an outside circumference of the base 212. The base 212 and the side wall portion 211 may be formed as one unit by pressing one sheet of steel plate.

Mounted to an inside of the side wall portion 211, there are the plurality of permanent magnets 216 along a circumferential direction. The permanent magnets 216 are magnetized as an N pole and an S pole alternately along the circumferential direction. According to this, the side wall portion 211 serves as a back yoke which forms a magnetic path.

In the meantime, the rotor frame 210 having the base 212 and the side wall portion may be formed as one unit by injection molding. In this case, it is required that the side wall portion 211 has an annular magnetic back yoke 111 mounted thereto, additionally.

At a central portion of the base 212 of the rotor 200, there is a hub portion 213 protruded upward for reinforcing rigidity of the base 212. The hub portion 213 has a central pass through hole 219 where a rotation shaft (not shown), for an example, a rotation shaft of the washing machine is positioned.

The rotation shaft and the hub portion 213 are connected with a connector or the like (not shown). According to this, as the rotor 200 rotates, the rotation force is transmitted from the rotor 200 to the rotation shaft.

The hub portion 213 has fastening holes 214 for fastening the connector 140, or positioning holes 215 for fixing a position of the connector at first.

The hub portion 200 is placed in the stator 100, and rotates with respect to the stator 100 owing to interaction with the stator 100. Of course, the rotation force of the rotor 200 is transmitted to the rotation shaft which is connected to the rotor frame to rotate as one unit.

In the meantime, the present invention is characterized in that, not the coil of copper of the related art, but a coil of aluminum core line 160b, is used. Aluminum has an inside resistance greater than copper. Therefore, in order to reduce the inside resistance, it is required that the coil of aluminum core line 160b has an outside diameter greater than the coil of copper.

Aluminum has ductility lower than copper. Therefore, aluminum is susceptible to breakage by external impact at the time of winding. Along with this, aluminum is weak to water, particularly, to salt water, such that the aluminum is in contact with salt water, aluminum is corroded easily to breakage.

Therefore, in the motor of the present invention, it is preferable that the coil of aluminum has a double coating film applied to an outside of the core line of aluminum for reinforcing strength and ductility. Along with this, the double coating film reinforces insulation of the coil.

In the meantime, as described before, the terminals of the coil are positioned at the power connection tap terminal 128 and the neutral point tap terminal 129, respectively. Such terminals of the coil are required to have the coating films removed therefrom to expose the core line for electric connection.

According to this, as described before, the terminal portions of the coil having core lines exposed thus have weak strength and ductility susceptible to breakage, and susceptible to corrosion when the core lines are in contact with water, particularly, to salt water.

For an example, the home appliance, such as the washing machine, the dryer, and dish washer, uses not only cold water, but also hot water, or hot air. Therefore, the home appliance is operated in a humid and high temperature environment. Therefore, strength and insulation of the terminal portions of the coil having the exposed core lines is specially important in the home appliance.

The power connection tap terminal 128 and the neutral point tap terminal 129 will be described in detail.

The power connection tap terminal 128 has a structure similar to the neutral point tap terminal 129. For an example, though the neutral point tap terminal 129 has terminals of three coils of u, v, w phases positioned thereto, the power connection tap terminal 128 has only a terminal of one coil of a specific phase u, v, or w positioned thereto. Therefore, for convenience sake, the neutral point tap terminal 129 will be described as representing one.

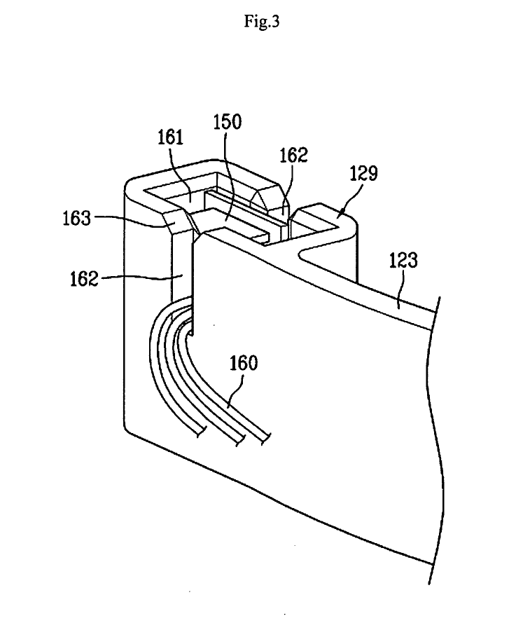

The neutral point tap terminal 129 will be described with reference to FIGS. 3 to 12.

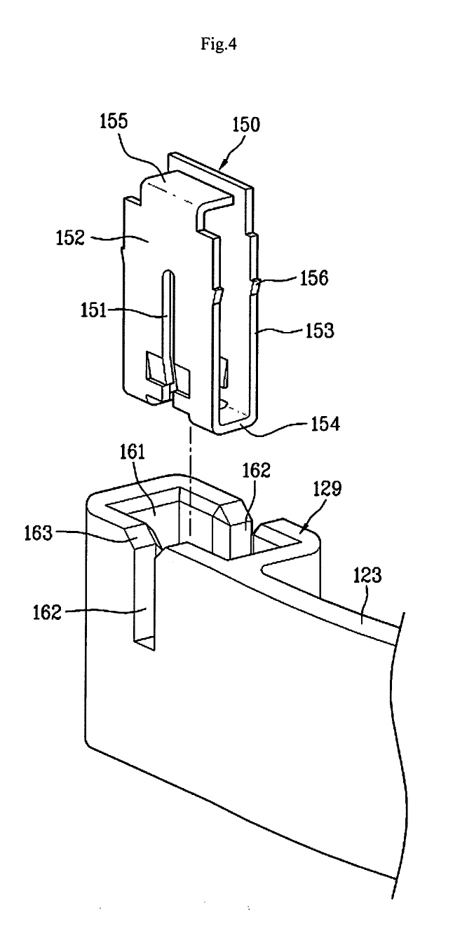

FIG. 3 illustrates a perspective view of the neutral point tap terminal in accordance with a preferred embodiment of the present invention, and FIG. 4 illustrates an exploded perspective view of a neutral point tap terminal in accordance with a preferred embodiment of the present invention.

Referring to FIGS. 3 and 4, the tap terminal 129 has a space 161 formed therein for placing a magmate 150 therein. There are slots in front and rear of the space 161 for holding the terminal of the coil 160. It is preferable that a top portion of the slot 162 is chamfered or rounded 163 for easy placing of the coil 160 therein.

In the meantime, the tap terminal 129 may have one side connected to the insulator rib 123. That is, the tap terminal 129 may be formed as one unit with the upper insulator 120. However, a structure of the tap terminal 129 is not limited to this, but may be formed at the bracket or the base 212. Moreover, the tap terminal 129 may be exposed to an outside of the bracket such that the tap terminal 129 is joined with the connector 140 easily on the outside of the bracket.

The magmate 150 has a C shape with slots 151 in a front 152, a rear 153, and a bottom 154, respectively. Of course, it is preferable that the slots 151 are formed in the middle of the front 152, the rear 153, and the bottom 154, respectively.

It is preferable that the coil 160 is forcibly placed in the slots 151 such that the core lines are exposed and connected to the magmate 150, electrically. Therefore, it is required that the magmate 150 is formed of a conductive material. Of course, after exposing the core lines 160b of the coil 160, the magmate 150 may be connected to the core lines 160b, electrically.

In this instance, the magmate 150 may not have the slots 151. That is, the magmate 150 may have a specific portion that is to be brought into contact with the core lines 160b of the coil 160, and the specific portion may have an insulation portion formed thereon.

In order to reinforce strength of the magmate 150, the front 152, the rear 153 of the magmate 150 are formed parallel to each other, and the bottom portion 154 is formed perpendicular to the front 152 and the rear 153. Moreover, the magmate 150 may have a top 155 parallel to the bottom 154 to have a □ shape on the whole.

The magmate 150 may have opposite opened sides, and in this case an entire shape of the magmate 150 may be formed by bending. Moreover, the magmate 150 may have hooks 156 on opposite sides. Of course, in conformity with the hooks 156, recesses or projection (not shown) may be formed in the space 161 of the tap terminal 129. According to this, if the magmate 150 is placed in the tap terminal 129, the magmate 150 is held by the hooks 156 such that the magmate 150 can not escape from the tap terminal 129, easily.

In this instance, as described before, the electric connection of the terminal of the coil 160 to the magmate 150 can be made as the core lines are exposed at the same time with placing the magmate 150 in the space 161 of the tap terminal 129 after the terminal of the coil 160 is positioned in the slots 162 in the tap terminal 129. However, the electric connection may also be made at the same time with the placing the magmate 150 in the tap terminal 129 after the core lines are exposed.

In the meantime, the terminal of the coil 160 and the connection portion of the magmate 150 have insulation portions additionally for reinforcing, corrosion prevention, and insulation. The insulation portion may be formed in various forms.

The tap terminal 129 having the insulation portion formed thereon may be the power connection tap terminal 128 or the neutral point tap terminal 129. However, for convenience of description, only the neutral point tap terminal 129 will be described, and the same things will be applicable to the power connection tap terminal 129.

For an example, referring to FIG. 3, though the neutral point tap terminal 129 has the terminals of the coils 160 of respective phases, i.e., three coils 160, connected thereto, the power connection tap terminal 128 has the terminal of a specific coil 160, i.e., only one coil 160 connected thereto. Of course, in each of the cases, the magmate 150 may have different shapes, which will be described later.

The insulation portions at the terminal portion of the coil 160 and the connection portion of the magmate 150 will be described in detail, with reference to the attached drawings.

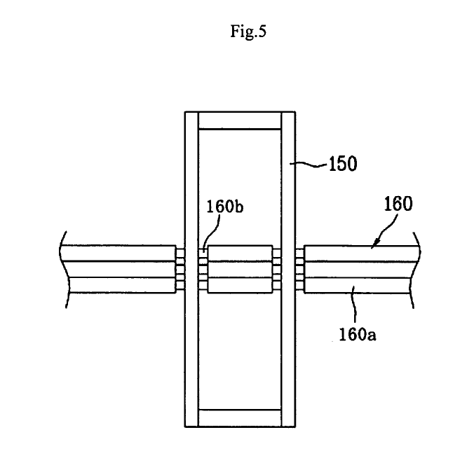

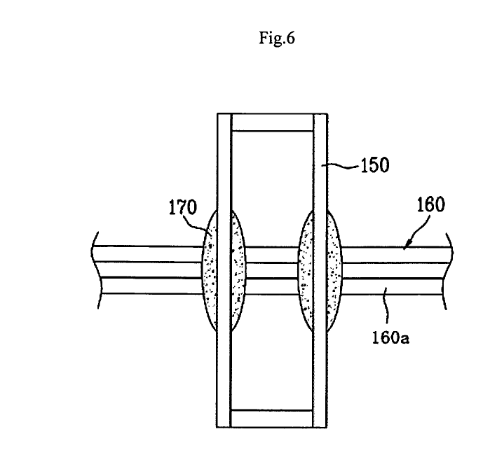

FIG. 5 illustrates a plan view showing a state of connection of a neutral point tap terminal to a coil in accordance with a preferred embodiment of the present invention, and FIG. 6 illustrates a plan view showing a state of insulation portions at the time of connection of a neutral point tap terminal to a coil in accordance with a preferred embodiment of the present invention. FIGS. 5 and 6 illustrate electric connection of the magmate 150 to the terminal of the coil 160, schematically.

The magmate 150 and the terminal of the coil are connected in the tap terminal 129 electrically, as the core lines 160b of the coil 160 are brought into direct contact to the magmate 150 of a conductive material. According to this, a specific portion of the coil 160 in direct contact with the magmate 150 is in a state the coating film 160a is removed therefrom.

Therefore, as described before, if the coil 160 shakes or has an external impact applied thereto, it is liable that the core lines 160b of the coil 160 in direct contact with the magmate 150 are broken, or corrosion due to aluminum of the core lines 160b of the coil 160.

In order to prevent this problem from taking place in advance, It is preferable that the insulation portion is formed at a portion where the core lines 160b of the coil 160 are in contact with the magmate 150. As one example of the insulation portion, a state resin 170 is coated on the portion is illustrated in FIG. 6.

The resin 170 is an insulating material, and set after application to maintain insulation of the core lines 160b to protect the core lines 160b against an outside harm. Of course, direct application of an external force to the core lines 160b is cut off to serve to reinforce strength of the core lines 160b.

Though the insulation portion is formed at the connection portion of the magmate 150 to the core lines 160b for insulation and protection of the core lines 160b, the resin 170 may be filled in the space 161 of the tap terminal 129, for insulation and protection of the core lines 160b.

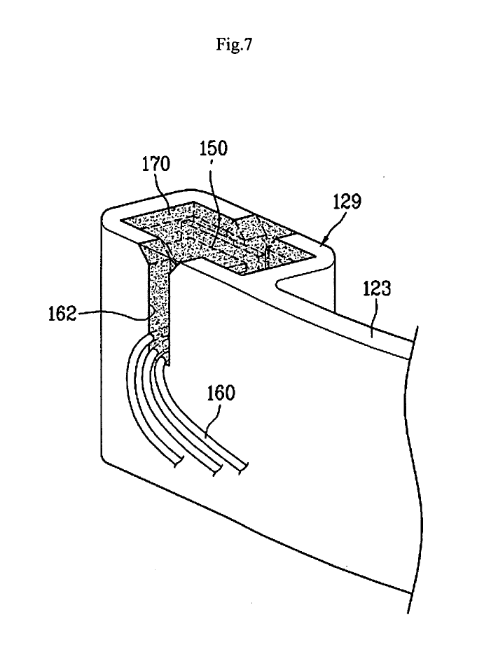

FIG. 7 illustrates a perspective view showing a state of coating of insulation portions at the time of connection of a neutral point tap terminal to a coil in accordance with a preferred embodiment of the present invention.

Referring to FIG. 7, the resin 170 is filled in the space 161 of the tap terminal 129, fully. That is, the resin 170 is coated such that the resin 170 encloses not only the magmate 150 and the exposed portions of the core lines 160b of the coil 160, but also portions of the coil 160 having the coating film 160a not removed therefrom.

In this case, though more resin 170 may be required, firmer fastening of the terminal of the coil 160 to the tap terminal 129 can be possible, and more reliable insulation can be secured, and more reliable corrosion prevention can be made.

Moreover, in this case, it is preferable that the tap terminal 129 is, not the power connection tap terminal 128, but the neutral point tap terminal 129. Because the neutral point tap terminal 129 does not required electric connection to portions other than the coil 160.

In the meantime, if the tap terminal 129 is the power connection tap terminal 128, it is required that the magmate 150 is connected to a power source. For this connection, it is preferable that at least a portion of the power connection tap terminal 128 has no resin 170 applied thereto.

The magmate 150 may have other shape for connection to an external power source.

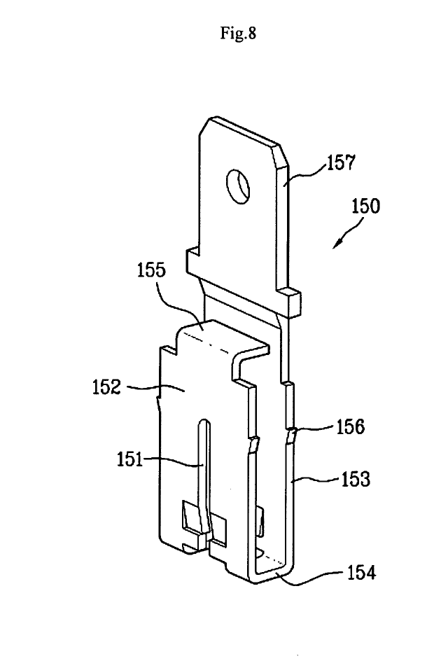

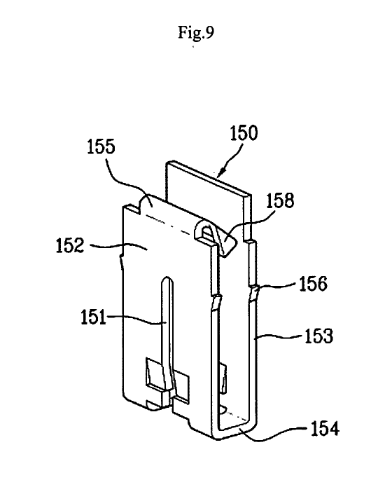

FIG. 8 illustrates a perspective view of a magmate of a neutral point tap terminal in accordance with a preferred embodiment of the present invention, and FIG. 9 illustrates a perspective view of a magmate of a neutral point tap terminal in accordance with another preferred embodiment of the present invention. As shown in FIGS. 8 and 9, the magmate 150 has a connection portion 157 or 158 additionally for connection to an external power source.

The connection portion 157 may be projected outwardly from the tap terminal 128 as a portion of the front 152 or the rear 153 of the magmate 150. The connection portion 157 is placed in the connector 140 at the time of connection of the connector 140 (See FIG. 1) to the tap terminal 128 for connection to the external power source.

That is, different from the magmate 150 in FIG. 3, the magmate 150 in FIG. 8 has the connection portion 157 projected outwardly from the tap terminal 128 for connection to the external power source.

The connection portion 158, a type in which a top 155 of the magmate 150 is modified, may be sloped inwardly. In this case, a terminal of the connector 140 is placed in the magmate 150 and brought into contact with the connection portion 158, thereby making electric connection.

That is, the magmate 150 may have the connection portion 157 or 158 additionally for connection to an external power spruce, and the connection portion 157 or 158 may be formed on an outside or inside of the magmate 150 as required.

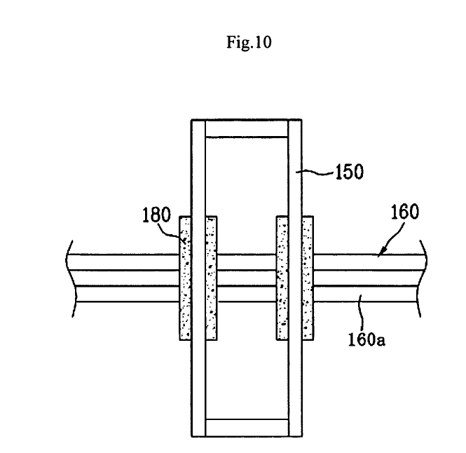

The insulation portion in accordance with another preferred embodiment of the present invention will be described with reference to FIG. 10.

FIG. 10 illustrates a plan view showing a state of insulation portions at the time of connection of a neutral point tap terminal to a coil in accordance with another preferred embodiment of the present invention.

The foregoing embodiment suggests forming the insulation film after the core lines 160b of the coil 160 is connected to the magmate 150 electrically, which is a type in which the resin 170 is coated on exposed portions of the core lines 160b.

However, the following embodiment suggests a film 180 which serves as the insulation portion is adhered to the magmate 150 in advance. That is, the film 180 is adhered to the slots 151 in the magmate 150, to form insulation coatings. The film 180 may be adhered to outside and inside walls of the front 152 and the rear 153 of the magmate 150.

Or, the film 180 may be adhered only around the slots 151 except the slots 151. Of course, since the coil is placed in the slot 151 in the bottom 154 of the magmate 150 at first, it is preferable that the film 180 is not adhered thereto for placing the coil 160 therein.

In the meantime, the film 180 may be adhered to block the slots 151 in the front 152 and the rear 153 of the magmate 150. In this case, at the time of placing in the coil 160, it is liable that the film 180 is torn or crumpled partially and wrap around the coil 160.

As described before, it is preferable that the film 180 is a thermo-setting type film that melts when heated, and sets as the film is cooled down, so that the film 180 melts as the film 180 is heated, to form an insulation coating at the portion of the core lines 160b of the coil 160.

That is, it is possible to melt the film 180 provided to exposed portions of the core lines 160b in advance for forming the insulation coating only at the exposed portions of the core lines 160b, effectively.

In the meantime, each of the foregoing embodiments may have a structure for reinforcing strength of the tap terminal 129 additionally. The tap terminal in accordance with another preferred embodiment of the present invention will be described with reference to the attached drawings.

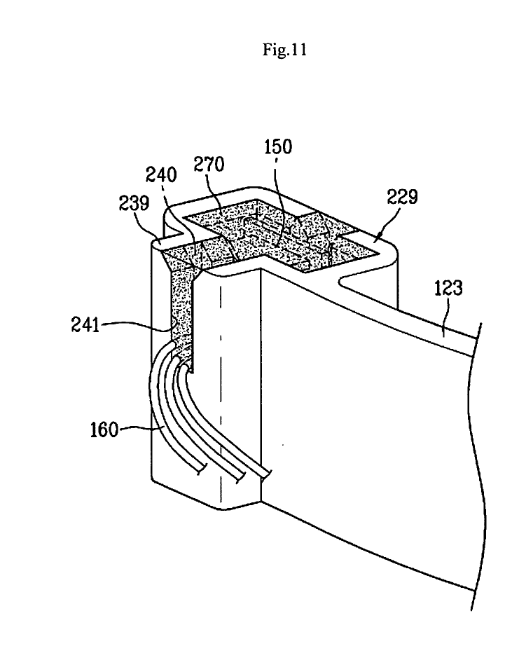

FIG. 11 illustrates a perspective view of a neutral point tap terminal in accordance with another preferred embodiment of the present invention.

Referring to FIG. 11, the tap terminal 229 is similar to the tap terminal of the foregoing embodiments, except that a structure is added separately for reinforcing strength of the tap terminal. Accordingly, description of the tap terminal structure will be omitted. Though a neutral point tap terminal 229 is shown as the tap terminal 229 described hereafter, the tap terminal 229 may also be applicable to the power connection tap terminal 128.

Referring to FIG. 11, the tap terminal 229 has a strength reinforcing portion 239 on an outer side of the space 161 having the magmate 150 placed therein. The strength reinforcing portion 239 may be formed on an inner side and/or an outer side of the tap terminal 229 in a radial direction.

However, if convenience of fastening of the terminal of the coil 160 is taken into account, it is preferable that the strength reinforcing portion 239 is formed on the outer side of the tap terminal in the radial direction, as one unit with the upper insulator 120.

In this instance, if tension acts on the coil 160, not the portion at which the coil 160 and the magmate 150 are connected, i.e., the exposed portion of the core lines 160b, takes the tension directly, but the coil 160 at a portion of the strength reinforcing portion 239 takes the tension.

In the meantime, alike the tap terminal 229, it is preferable that the strength reinforcing portion 239 has a slot 241. According to this, as the terminal of the coil 160 is held at the slot 241 of the strength reinforcing portion 239 and the slots 162 in the tap terminal 229, strength is further reinforced.

It is preferable that each of the slots 241 and 162 have a width in conformity with an outside diameter of the coil 160. That is, as shown in FIG. 11, it is preferable that each of the widths of the slots 241 and 162 is formed smaller than the outside diameter of the coil 160 to some extent, such that the coil 160 is forcibly placed therein for fastening the coil 160 at a time. However, it is more preferable that the width is not excessively smaller than the outside diameter of the coil 160 for prevention of damage of the coating film 160a.

Along with this, it is preferable that the strength reinforcing portion 239 has a pocket 240 formed therein. It is preferable that the pocket is in communication with an inside of the tap terminal 229 through the slot 162. According to this, the coil 160 is fastened to the tap terminal 229, crossing the pocket 240.

In this embodiment too, resin 270 may be coated as the insulation portion. In this case, it is not desirable that an amount of the resin 270 on a top of the tap terminal 229 is so excessive that the resin 270 overflows to an outside of the tap terminal 229. It is preferable that the resin 270 is made to overflow to the pocket 240 of the strength reinforcing portion 239 even if the resin 270 overflows.

By doing this, a fixed amount of the resin 270 can be coated, not manually, but automatically, enabling to simplifying a production process.

Along with this, the coating of the resin 270 to many portions has advantages in that effective reinforcing, insulation, and corrosion prevention of the terminal of the coil 160 can be achieved. In the meantime, the insulation film of the foregoing embodiment is applicable to this embodiment, too.

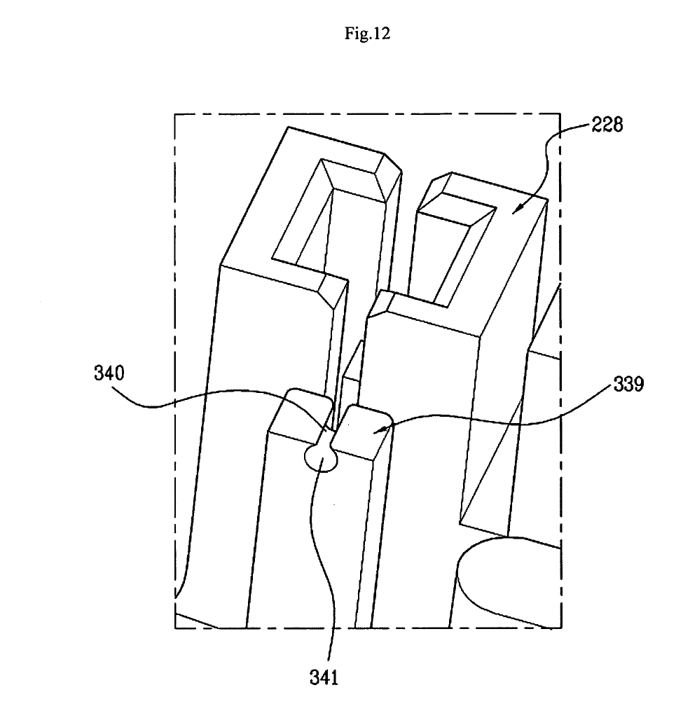

In the meantime, the strength reinforcing portion 239 may have a form for fastening the coil thereto, which will be described in detail with reference to FIG. 12.

FIG. 12 illustrates a perspective view of a neutral point tap terminal in accordance with another preferred embodiment of the present invention.

Referring to FIG. 12, different from the strength reinforcing portion 239 shown in FIG. 239, the strength reinforcing portion 339 has a height lower than the tap terminal 229.

The coil 160 placed in the pocket 240 of the strength reinforcing portion 239 shown in FIG. 11 can move up/down if no resin is applied to the pocket 240. Opposite to this, the coil 160 placed in the strength reinforcing portion 339 shown in FIG. 12 can not move up/down. To do this, the strength reinforcing portion 339 has an insertion portion 340 for inserting the coil 160 and a seating portion 341 for seating the coil 160.

The insertion portion 340 has a width for permitting forced insertion of the coil 160, and the seating portion 341 has a width greater than a width of the insertion portion 340. According to this, once the coil is inserted through the insertion portion 340 and seated on the seating portion 341, the up/down movement of the coil 160 can be prevented, which reinforces strength of the terminal of the coil 160 because, not the exposed portion of the core lines 160b of the coil 160, but a portion of the coil 160 seated on the seating portion 341 takes the tension, directly.

Along with this, since the coil 160 inserted through the insertion portion 340 does not escapes from the insertion portion 340 easily, secure strength reinforcement of the terminal of the coil 160 can be made even later on.

It is preferable that the seating portion 341 of the strength reinforcing portion 239 has a curved surface in conformity with an outside circumference of the coil as shown in the drawing for increasing a contact area of the seating portion 341 to the coil 160.

In the meantime, the foregoing various embodiments are characterized in that the core line 160b of the coil 160 wound on the stator 100 is formed of, not copper of the related art, but aluminum. Along with this, the insulation portion is provided for strength reinforcement, insulation, and corrosion prevention of the core line 160b.

Connection of the coil to the tap terminal of the motor will be described.

The coil 160 having the aluminum core line 160b is wound on the stator core 110. Then, the terminal of the coil 160 is connected, electrically. That is, either the neutral point or the power connection point is formed, and for easy fabrication and safe connection, the terminals of the coil 160 are positioned at the tap terminal 129.

The tap terminal 129 may have the magmate 150 placed therein for electric connection and fastening of the terminals of the coil 160. That is, the magmate 150 is brought into contact with the coils 160 in the tap terminal 129 to form a neutral point between the coils 160, or a connection point for connection to an external power source. The connection point herein is the connection portion 157 or 158.

Eventually, as the magmate 150 fastens the coil 160 to the tap terminal 129, the electric connection is made.

Then, at the portion where the magmate 150 and the terminal of the coil 160 are connected, i.e., the portion where the core line 160b of the coil 160 is exposed, the insulation coating is formed. That is, the insulation portion is formed. The insulation portion is provided for corrosion prevention and strength reinforcement of the core line 160b.

In this instance, the insulation portion may be the resin 170 coated for forming an insulation coating on the exposed portion of the core line 160b. That is, the resin 170 serves as the insulation coating. The insulation portion may be provided to the magmate 150, to form the insulation coating at the exposed portion of the core line 160b as the insulation portion is melt.

As the insulation portion is melt by heating, and set by cooling, the insulation portion can insulate and reinforce the strength.

As has been described, the motor, a method for fabricating the same, and a home appliance with the same of the present invention have the following advantages.

The cost reduction of the coil 160 applicable to the motor permits production cost reduction of the motor on the whole, as well as the home appliance having the motor applied thereto.

The present invention permits to provide a motor of which production cost is reduced, fabrication is easy, reliability and a lifetime is enhanced, and a method for fabricating the same.

Along with this, the present invention can provide a motor having a quality equal to, or higher than the related art motor even without changing essential elements of the related art motor.

Especially, the present invention permits provide a motor having enhanced reliability and lifetime even in a humid environment a temperature higher than a room temperature, and a motor and a home appliance having connection portions of which defects are minimized.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A motor comprising:
a stator having a coil wound thereon;
a rotor mounted to be rotatable with respect of the stator;
a tap terminal positioned at a terminal of the coil;
a magmate placed in the tap terminal for electric connection to a core line of the coil and fastening the coil to the tap terminal; and
an insulation portion at the magmate for forming an insulation coating at an exposed portion of the core line.

2. The motor as claimed in claim 1, wherein the stator includes;
a stator core, and
an insulator for insulating the stator core.

3. The motor as claimed in claim 1 wherein the coil is formed of aluminum.

4. The motor as claimed in claim 2, wherein the tap terminal is mounted to the insulator.

5. The motor as claimed in claim 2, wherein the tap terminal is formed as one unit with the insulator.

6. The motor as claimed in claim 1, wherein the tap terminal is either a power connection tap terminal, or a neutral point tap terminal.

7. The motor as claimed in claim 1, further comprising a strength reinforcing portion at one side of the tap terminal for reinforcing strength of the tap terminal and the terminal of the coil.

8. The motor as claimed in claim 7, wherein the strength reinforcing portion is formed as one unit with the tap terminal.

9. The motor as claimed in claim 7, wherein the strength reinforcing portion includes an insertion portion for inserting the coil therein and a seating portion for seating the coil thereon.

10. The motor as claimed in claim 9, wherein the insertion portion has a width for enabling forced insertion of the coil therethrough, and the seating portion has a width greater than the width of the insertion portion.

11. The motor as claimed in claim 9, wherein the seating portion has a curved surface for increasing a contact area to the coil.

12. The motor as claimed in claim 1, wherein the magmate includes a front, a rear, and a bottom, and the front, the rear, and the bottom have slots in the middles of the front, the rear, and the bottom respectively for placing the coil therein.

13. The motor as claimed in claim 12, wherein the magmate is formed such that the front and the rear are parallel to each other, and the bottom is bent perpendicular to the front and the rear for reinforcing strength.

14. The motor as claimed in claim 12, wherein the insulation portion is provided to portion excluding slot portions of the front and the rear of the magmate.

15. The motor as claimed in claim 12, wherein the insulation portion is provided to an inside wall and an outside wall of each of the front and the rear of the magmate.

16. The motor as claimed in claim 1, wherein the insulation portion is provided to portions of the magmate excluding a portion of the magmate in contact with the core line.

17. The motor as claimed in claim 1, wherein the magmate includes a connection portion for connection to an external power source.

18. The motor as claimed in claim 14, wherein the connection portion is formed to be projected to an outside of the tap terminal.

19. The motor as claimed in claim 14, wherein the connection portion is sloped to an inside of the magmate.

20. The motor as claimed in claim 1, wherein the insulation portion is a thermosetting type film to be adhered to the magmate.

21. A home appliance operable by rotation force of a motor, comprising a base for mounting the motor thereon and a connector for applying an external power source to the motor,
wherein the motor includes;
a stator fixed to the base,
a rotor mounted to be rotatable with respect of the stator,
a tap terminal positioned at a terminal of the coil,
a magmate placed in the tap terminal for electric connection to a core line of the coil and fastening the coil to the tap terminal, and
an insulation portion at the magmate for forming an insulation coating at an exposed portion of the core line.

22. The home appliance as claimed in claim 21, wherein the stator includes;
a stator core, and
an insulator for insulating the stator core.

23. The home appliance as claimed in claim 21, wherein the coil is formed of aluminum.

24. The home appliance as claimed in claim 22, wherein the tap terminal is mounted to the insulator.

25. The home appliance as claimed in claim 22, wherein the tap terminal is formed as one unit with the insulator.

26. The home appliance as claimed in claim 21, wherein the tap terminal is either a power connection tap terminal, or a neutral point tap terminal.

27. The home appliance as claimed in claim 21, further comprising a strength reinforcing portion at one side of the tap terminal for reinforcing strength of the tap terminal and the terminal of the coil.

28. The home appliance as claimed in claim 27, wherein the strength reinforcing portion is formed as one unit with the tap terminal.

29. The home appliance as claimed in claim 27, wherein the strength reinforcing portion includes an insertion portion for inserting the coil therein and a seating portion for seating the coil thereon.

30. The home appliance as claimed in claim 29, wherein the insertion portion has a width for enabling forced insertion of the coil therethrough, and the seating portion has a width greater than the width of the insertion portion.

31. The home appliance as claimed in claim 29, wherein the seating portion has a curved surface for increasing a contact area to the coil.

32. The home appliance as claimed in claim 31, wherein the magmate includes a front, a rear, and a bottom, and the front, the rear, and the bottom have slots in the middles of the front, the rear, and the bottom respectively for placing the coil therein.

33. The home appliance as claimed in claim 32, wherein the magmate is formed such that the front and the rear are parallel to each other, and the bottom is bent perpendicular to the front and the rear for reinforcing strength.

34. The home appliance as claimed in claim 32, wherein the insulation portion is provided to portion excluding slot portions of the front and the rear of the magmate.

35. The home appliance as claimed in claim 32, wherein the insulation portion is provided to an inside wall and an outside wall of each of the front and the rear of the magmate.

36. The home appliance as claimed in claim 21, wherein the insulation portion is provided to portions of the magmate excluding a portion of the magmate in contact with the core line.

37. The home appliance as claimed in claim 21, wherein the magmate includes a connection portion for connection to an external power source.

38. The home appliance as claimed in claim 24, wherein the connection portion is formed to be projected to an outside of the tap terminal.

39. The home appliance as claimed in claim 24, wherein the connection portion is sloped to an inside of the magmate.

40. The home appliance as claimed in claim 21, wherein the insulation portion is a thermosetting type film to be adhered to the magmate.

41. A method for fabricating a motor comprising:
(A) step for winding aluminum coil on a stator core;
(B) step for positioning a terminal of the coil at a tap terminal;
(C) step for placing a magmate in the tap terminal for connecting a core line of the coil to the magmate electrically, and fastening the coil to the tap terminal; and
(D) step for forming an insulation coating on an exposed portion of the core line for corrosion prevention and strength reinforcement of the core line.

42. The method as claimed in claim 41, wherein the (D) step includes the step of heating the magmate for melting an insulation portion mounted to the magmate.

43. The method as claimed in claim 41, wherein the (D) step includes the step of coating resin on the tap terminal.
